(19) United States
(12) Patent Application Publication
(10) Pub. No.: US 2015/0266254 A1
(43) Pub. Date: Sep. 24, 2015

(54) SINGLE-SERVING FOOD PACKAGING WITH STEAM VENTS

(71) Applicant: Sierra Packaging & Converting, LLC, Reno, NV (US)

(72) Inventor: Robert E. Yarhi, Reno, NV (US)

(73) Assignee: Sierra Packaging & Converting, LLC, Reno, NV (US)

(21) Appl. No.: 14/219,309

(22) Filed: Mar. 19, 2014

(51) Int. Cl. B31B 19/20

(52) U.S. Cl. CPC B31B 19/20; B31B 2201/147; B31B 2201/26; B31B 2201/6073

(57) ABSTRACT

A method of constructing a single-serving microwaveable food package is disclosed. Laser-cut steam vent apertures are formed in a line parallel to a top edge of a packaging sheet, the line comprising a first and a second set of vent apertures. The packaging sheet is folded such that a bottom edge is aligned with the top edge. The folded packaging sheet comprises a front layer and a back layer. A parallel seal is created below the line of apertures from a right edge to a left edge, wherein the front layer is sealed to the back layer along the parallel seal. The right edge of the folded packaging sheet is sealed, wherein the front layer is sealed to the back layer along the right edge. The left edge of the folded packaging sheet is sealed, wherein the front layer is sealed to the back layer along the left edge.

### BACKGROUND

1. Field of the Invention

The present invention generally relates to food packaging. More specifically, the present invention relates to a method of constructing single-serving food packaging with laser-cut steam vents.

2. Description of the Related Art

Microwave ovens are present in nearly every kitchen. Supermarkets now carry a vast assortment of microwavable food products. However, in many microwaveable products, the heat generated inside the food packaging needs to be handled carefully to prevent injury and improper cooking of the food contained within the microwaveable package.

Prior approaches to solving this problem include requiring the user to cut open a portion of a plastic pouch. Usually, this is only at one end of the package, and done simply to prevent a pressure build-up within the plastic pouch. This does not allow proper airflow, and in some cases can allow food to spill out of the package during cooking or handling. In another approach, a clip is attached to the pouch after it is opened to close the package yet allow the package to vent, but some users will fail to attach the clip properly. Thus, leakage may still occur.

In an improved solution, very small perforations are made by a laser on portions of a plastic pouch. These perforations may be on opposite sides of one panel of a plastic pouch in a strip pattern. The perforations are quite small and in some cases unnoticeable to the human eye, and do not require the user to slit open the pouch or open any portion of the pouch. Examples of laser-perforated food packaging are described in U.S. Pat. Nos. 8,112,974 and 7,723,656, both entitled “Microwaveable Food Package.” In the case of frozen food, the perforations can be oriented on one side of the pouch, so that the pouch can be laid on a plate or other surface inside the microwave oven when the perforations facing up, so that no food leaks out of the pouch as the pouch cooks. One main benefit realized from the present invention is a more uniform venting of the food while it cooks, so that the chance of scalding the user or improperly cooking the food is greatly reduced.

Although this improved approach to ventilation is efficient for large packaging, there is no equivalent for smaller, single-serve packages. Single-serve packaging has become popular for people who want to cook for only one or two people as opposed to an entire family. Approaches to single-serving food packaging include using small plastic containers covered with an air-tight plastic film, where the user pulls back a corner of the film for ventilation while cooking.

Therefore, there is a need in the art for improved ventilation in single-serve microwavable food packaging.

### SUMMARY OF THE CLAIMED INVENTION

The present invention provides a method for constructing microwaveable, single-serve food packaging with laser-cut perforations. The laser-cut perforations are small holes in at least one side of the packaging that provide ventilation for steam that builds up within the packaging when the food is being cooked in a microwave. The packaging sheet contains more than one single-serve pouch that a user may separate using a cutting implement such as scissors or a knife. Alternatively, the packaging may contain perforations between the single-serve pouches that allow for the single-serve pouches to be separated by the user without cutting the packaging.

### BRIEF DESCRIPTION OF THE DRAWINGS

FIG. 1A illustrates a packaging sheet with laser-cut steam vents.

FIG. 1B illustrates an assembled packaging sheet containing two single-serve pouches.

FIG. 1C illustrates an assembled single-serve pouch that has been separated from the other single-serve pouch.

### DETAILED DESCRIPTION

The present invention provides a method of constructing microwaveable, single-serve food packaging with laser-cut perforations. The laser-cut perforations are small holes in at least one side of the packaging that provide ventilation for steam that builds up within the packaging when the food is being cooked in a microwave. The packaging sheet contains more than one single-serve pouch that a user may separate from one another.

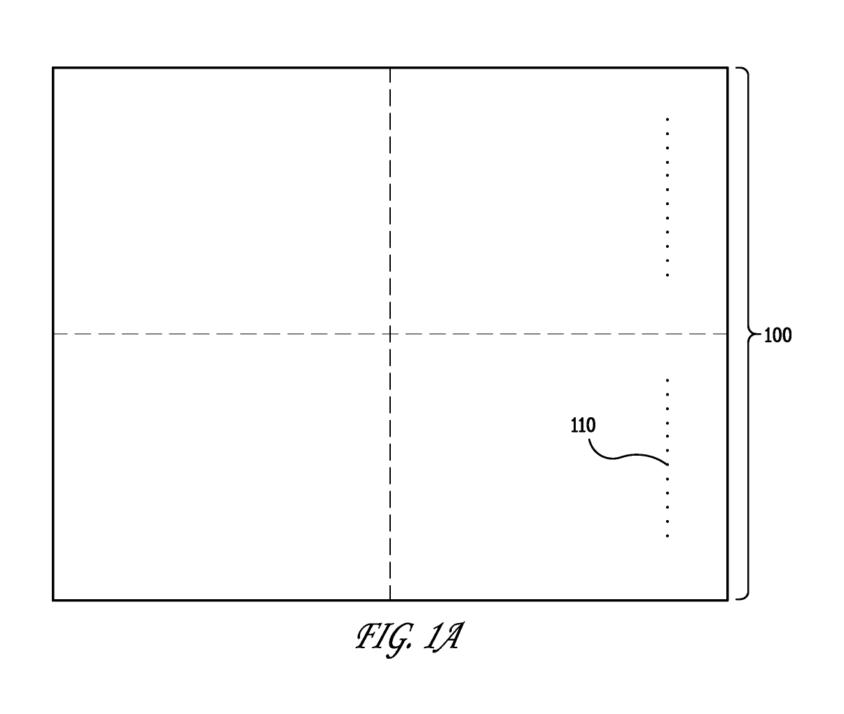

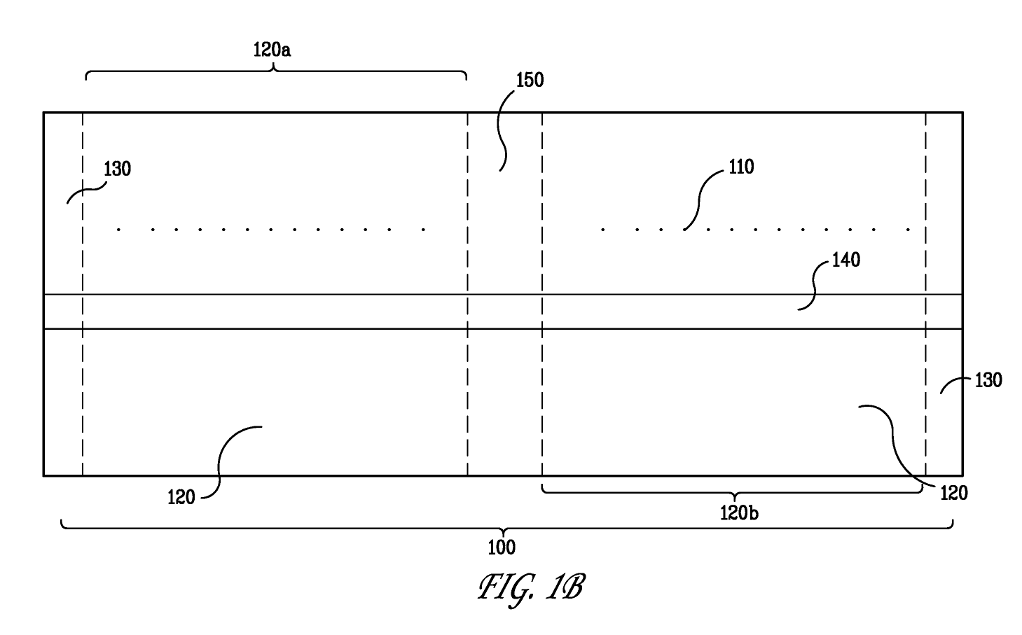

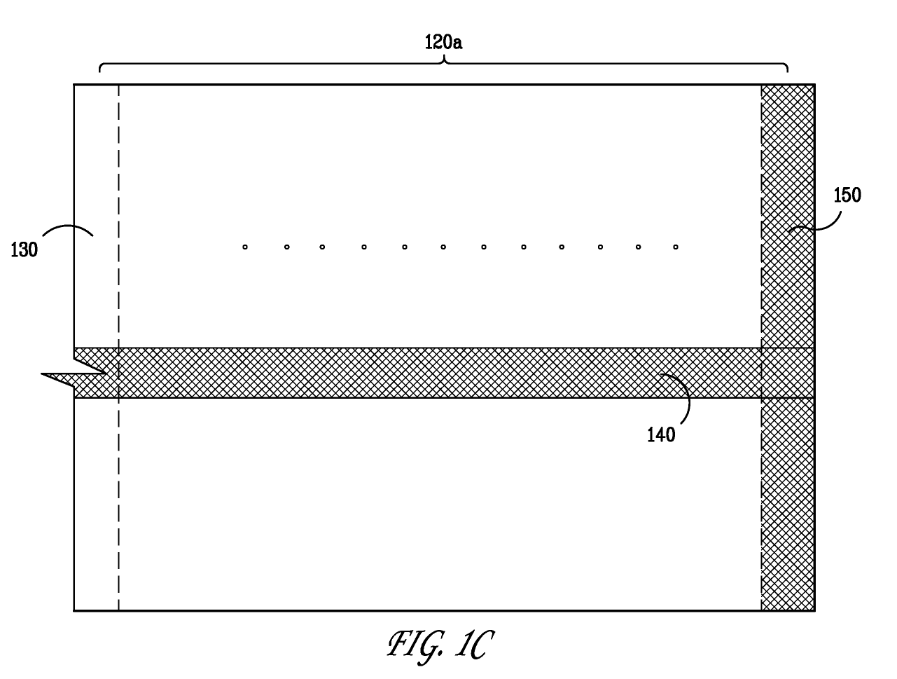

FIG. 1A illustrates a packaging sheet 100 with a plurality of laser-cut steam vent apertures, one of which is labeled 110, in a parallel line across the top of the packaging sheet 100. Steam vent apertures 110 may range in diameter from approximately 100 microns to approximately 800 microns, with a preferred diameter of 400 microns. The size of steam vent apertures 110 may depend on several factors, including the size of the food package, the oxygen transfer required during cooking, or aesthetic concerns.

Packaging sheet 100 may be polyester, oriented polypropylene, cast polypropylene, nylon, polyester (PET), polyethylene, or other suitable material. Packaging sheet 100 may comprise several layers of one or more of these materials depending on packaging needs, as will be known to those skilled in the art.

FIG. 1B illustrates an assembled packaging sheet 100 containing two single-serve pouches 120, which are created when the packaging sheet 100 of FIG. 1A is folded. Side seals 130 and center seal 140, which is shown as a lap seal, is formed in the center of pouches 120 to prevent contents from leaking out of the packaging.

The laser-cut steam vent apertures 110 of FIG. 1A may be seen above seal 140 on the left and right sides of the assembled packaging sheet 100. There are no vent apertures in the center of the assembled packaging sheet 100. The space between the vent apertures 110 is sealed by vertical seal 150, separating the contents of the first single-serve pouch 120A from the contents of the second single-serve pouch 120B.

A user may separate first single-serve pouch 120A from second single-serve pouch 120B using a cutting implement such as scissors or a knife. Alternatively, the packaging sheet 100 may contain perforations (not shown) between first single-serve pouch 120A and second single-serve pouch 120B that allow for the pouches to be separated by the user without the need to cut the packaging.

FIG. 1C illustrates an assembled single-serve pouch 120A that has been separated from single-serve pouch 120B. Pouch 120A is sealed by horizontal center seal 140, on the right by side seal 130, and on the left by vertical center seal 150.

Although the embodiment presented in FIGS. 1A-1C illustrate a packaging sheet that can be used to construct two separate single-serve pouches, it is contemplated that more than two pouches could be constructed from a single packaging sheet using the same method as described above.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A method of constructing a single-serving microwaveable food package, wherein the method comprises:
forming a plurality of laser-cut steam vent apertures in a line parallel to a top edge of a packaging sheet, wherein the parallel line comprises a first set of vent apertures on a right side and a second set of vent apertures on a left side of the packaging sheet;
folding the packaging sheet, wherein a bottom edge of the packaging sheet is aligned with the top edge of the packaging sheet and wherein the folded packaging sheet comprises a front layer and a back layer;
creating a parallel seal below the line of laser-cut steam vent apertures from a right edge of the packaging sheet to a left edge of the packaging sheet, wherein the front layer of the packaging sheet is sealed to the back layer of the packaging sheet along the parallel seal;
sealing the right edge of the folded packaging sheet, wherein the front layer of the packaging sheet is sealed to the back layer of the packaging sheet along the right edge; and
sealing the left edge of the folded packaging sheet, wherein the front layer of the packaging sheet is sealed to the back layer of the packaging sheet along the left edge.

2. The method of claim 1, wherein the parallel seal is a lap seal.

3. The method of claim 1, further comprising forming a plurality of laser-cut perforations in the sealed center section of the packaging sheet.

4. The method of claim 1, wherein the vent apertures are 400 microns in diameter.

5. The method of claim 1, wherein the packaging sheet comprises polyester.

6. The method of claim 1, wherein the packaging sheet comprises oriented polypropylene.

7. The method of claim 1, wherein the packaging sheet comprises cast polypropylene.

8. The method of claim 1, wherein the packaging sheet comprises nylon.

9. The method of claim 1, wherein the packaging sheet comprises polyesters (PET).

10. The method of claim 1, wherein the packaging sheet comprises polyethylene.

11. The method of claim 1, further comprising sealing a center section of the packaging sheet between the first set of vent apertures and the second set of vent apertures.
